(19) United States
(12) Patent Application Publication
(10) Pub. No.: US 2025/0001772 A1
(43) Pub. Date: Jan. 2, 2025

(54) MEDIUM SUPPLY SYSTEM AND IMAGE FORMING SYSTEM

(71) Applicant: FUJIFILM Business Innovation Corp., Tokyo (JP)

(72) Inventors: Yuichi ARAKI, Kanagawa (JP); Kazuhiko HORIKAWA, Kanagawa (JP); Ryosuke YONESAKA, Kanagawa (JP)

(73) Assignee: FUJIFILM Business Innovation Corp., Tokyo (JP)

(21) Appl. No.: 18/527,407

(22) Filed: Dec. 4, 2023

(30) Foreign Application Priority Data
Jun. 28, 2023 (JP) 2023-106491

(51) Int. Cl. B41J 11/42; B41J 11/00; B65H 7/06; G03G 15/00

(52) U.S. Cl. CPC B41J 11/42; B41J 11/0095; B65H 7/06; G03G 15/50; G03G 15/6502; B41J 2203/011; B65H 2553/42; G03G 2215/00717

(57) ABSTRACT

A medium supply system includes: imaging units that capture images of a plurality of stacked recording media from an edge side of the recording media; and at least one processor, wherein the processor stops supply of the recording media when it is determined that a fold is generated in the recording media from the images captured by the imaging units.

### CROSS-REFERENCE TO RELATED APPLICATIONS

This application is based on and claims priority under 35 USC 119 from Japanese Patent Application No. 2023-106491 filed Jun. 28, 2023.

### BACKGROUND

### (i) Technical Field

The present invention relates to a medium supply system and an image forming system.

### (ii) Related Art

A sheet supply apparatus described in JP2015-24868A includes: a tray on which a stack of sheets, which is formed with a plurality of vertically stacked sheets, can be placed; an air blowing section that blows air toward the stack of sheets placed on the tray to float at least a topmost sheet; a sucking and conveying section that is disposed above the tray and sucks the topmost sheet floated by the air blowing section and conveys the topmost sheet in a prescribed conveying direction; a first light source that emits first slit light, which is strip-shaped light having a component extending vertically, the first slit light crossing at least a first edge of a first sheet and a second edge of a second sheet below the first sheet, the first sheet and the second sheet being part of a plurality of floated sheets; an image capture section that captures an image of the first slit light, emitted to the first sheet and the second sheet, and is oriented in an image capture direction that is different, in a plane parallel to the first sheet and the second sheet, from a direction in which the first slit light is emitted from the first light source; a calculating section that calculates a vertical clearance between the first sheet and the second sheet according to the image of the first slit light, the image being captured by the image capture section; and an air amount adjusting section that adjusts an amount of air to be blown by the air blowing section, according to the vertical clearance between the first sheet and the second sheet, the vertical clearance being calculated by the calculating section.

### SUMMARY

Aspects of non-limiting embodiments of the present disclosure relate to a medium supply system that prevents supply of a recording medium that is folded as compared with a case where a recording medium is supplied without checking whether or not a fold is generated in the recording medium.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a medium supply system comprising:
imaging units that capture images of a plurality of stacked recording media from an edge side of the recording media; and
at least one processor,
wherein the processor stops supply of the recording media when it is determined that a fold is generated in the recording media from the images captured by the imaging units.

### BRIEF DESCRIPTION OF THE DRAWINGS

FIG. 1 is a schematic configuration diagram illustrating an image forming apparatus according to an embodiment of the present disclosure.

FIG. 2 is a perspective view illustrating a medium supply apparatus according to the embodiment of the present disclosure.

FIGS. 3A and 3B are cross-sectional views illustrating states in which air is supplied from edge portions to stacked sheet members in the medium supply apparatus according to the embodiment of the present disclosure.

FIGS. 4A and 4B are diagrams illustrating hardware configurations and functional configurations of a control unit provided in the medium supply apparatus according to the embodiment of the present disclosure.

FIG. 5 is a flowchart illustrating a flow of control by the control unit provided in the medium supply apparatus according to the embodiment of the present disclosure.

FIGS. 6A to 6F are views illustrating fold patterns stored in the control unit provided in the medium supply apparatus according to the embodiment of the present disclosure.

FIGS. 7A and 7B are a perspective view and a side view illustrating a folded state of the sheet members determined in the medium supply apparatus according to the embodiment of the present disclosure.

FIGS. 8A and 8B are a perspective view illustrating a folded state of the sheet members determined in the medium supply apparatus according to the embodiment of the present disclosure, and a view illustrating a graph used for determining a fold.

### DETAILED DESCRIPTION

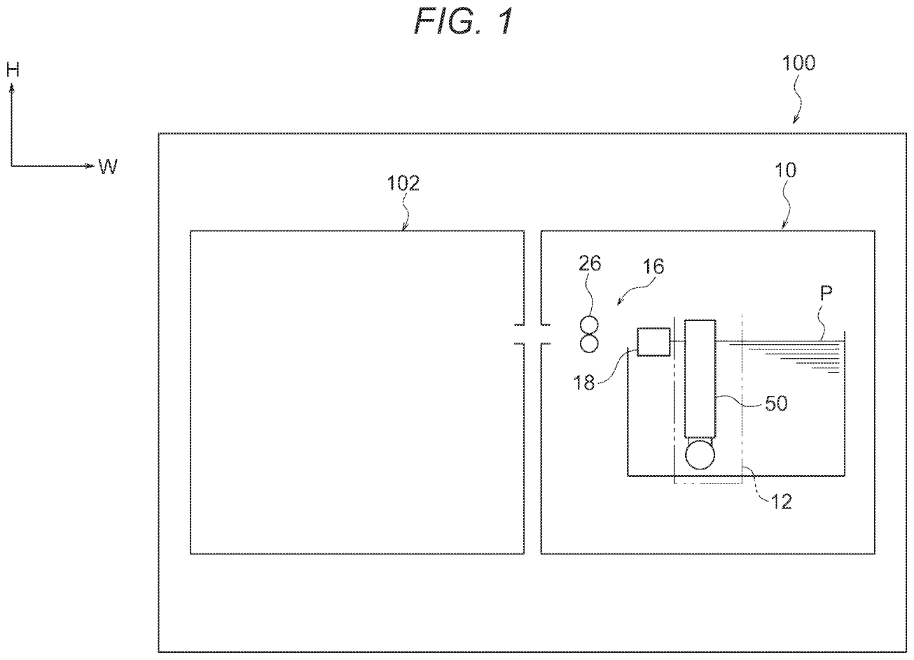

Examples of a medium supply apparatus and an image forming apparatus according to an embodiment of the present disclosure will be described with reference to FIGS. 1 to 8B. In the drawings, an arrow H indicates an apparatus up-down direction (vertical direction), an arrow W indicates an apparatus width direction (horizontal direction), and an arrow D indicates an apparatus depth direction (horizontal direction).

### Overall Configuration of Image Forming Apparatus 100

As illustrated in FIG. 1, an image forming apparatus 100 includes an image forming unit 102 that forms an image on a sheet member P, which is an example of a recording medium, and a medium supply apparatus 10 that supplies the sheet member P to the image forming unit 102. In addition, a transport section (not illustrated) that transports the sheet member P to an image formation position of the image forming unit 102 is provided inside the image forming apparatus 100. Note that the medium supply apparatus 10 may be attached to a main body of the image forming apparatus as an option or the like. The medium supply apparatus is an example of a medium supply system, the image forming apparatus 100 is an example of an image forming system, and the image forming unit 102 is an example of a processing apparatus.

### Overall Configuration of Medium Supply Apparatus 10

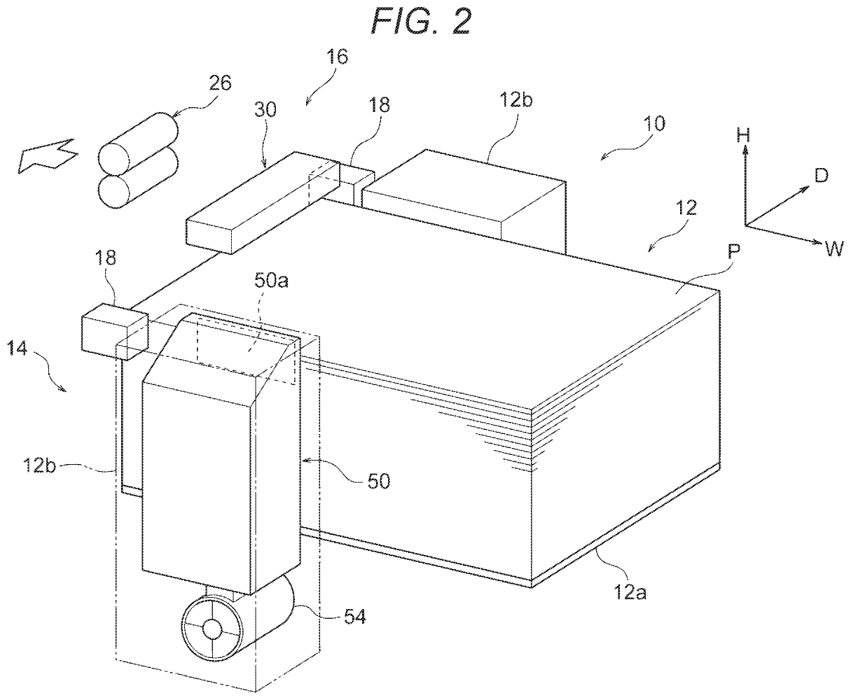

As illustrated in FIG. 2, the medium supply apparatus 10 includes a stacking unit 12 on which the sheet member P is stacked in the up-down direction, and a supply unit 14 that supplies air to a plurality of the sheet members P stacked on the stacking unit 12 to float and separate the sheet members P. Further, the medium supply apparatus 10 includes a transport unit 16 that sequentially transports the sheet members P floated and separated by the supply unit 14 to the image forming unit 102.

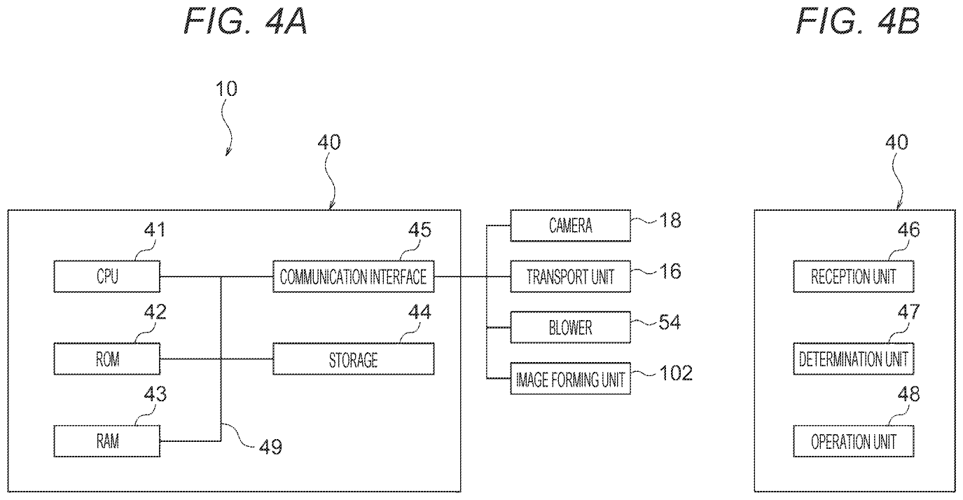

The medium supply apparatus 10 further includes cameras 18 each being an example of an imaging unit that captures an image of the sheet members P in the state of being floated and separated by the air supplied by the supply unit 14, and an irradiation unit (not illustrated) that irradiates a portion of the sheet members P whose image is captured by the cameras 18 with light. The medium supply apparatus 10 further includes a control unit 40 (see FIGS. 4A and 4B) that controls an operation of each unit.

### Stacking Unit 12

As illustrated in FIG. 2, the stacking unit 12 includes a bottom plate 12a on which the plurality of sheet members P can be stacked, and a lifting device (not illustrated) that lifts and lowers the bottom plate 12a in the up-down direction. The lifting device lifts the bottom plate 12a such that a position of an uppermost sheet member P of the sheet members P stacked on the bottom plate 12a becomes a predetermined height.

The stacking unit 12 includes a pair of side guides 12b that regulate positions of both edges of the sheet members P stacked on the bottom plate 12a in the width direction (a direction of the arrow D in this example). At least one of the side guides 12b is attached so as to be slidable in the apparatus depth direction which is the width direction of the sheet member P. Thus, the side guide 12b is configured to regulate the positions of both the edges of the sheet member P in the width direction by sliding the side guide 12b in the apparatus depth direction in accordance with a size of the sheet member P.

### Transport Unit 16

As illustrated in FIGS. 1 and 2, the transport unit 16 is disposed above the uppermost sheet member P among the plurality of sheet members P stacked on the bottom plate 12a of the stacking unit 12, and includes a suction unit 30 and a feeding roller 26.

The suction unit 30 is disposed above a leading end portion of the uppermost sheet member P with a gap from the uppermost sheet member P in a stacked state. Then, the suction unit 30 sucks the uppermost floating sheet member P and moves to one side (left in the drawing) in the apparatus width direction in a state of sucking the sheet member P to transport the sheet member P. Here, the leading end portion of the sheet member P is a portion including at least a portion having a length of 10 from a leading end when a length of the sheet member P in a supply direction is 100.

The feeding roller 26 is disposed on one side in the apparatus width direction with respect to the suction unit 30, receives the sheet member P transported by the suction unit 30, and transports the received sheet member P toward the image forming unit 102 (see FIG. 1).

### Supply Unit 14

As illustrated in FIG. 2, the supply unit 14 is disposed inside the side guide 12b on the front side in the apparatus depth direction, and includes a duct 50 in which a supply port 50a is formed, and a blower 54 that supplies air into the duct 50.

### Camera 18

As illustrated in FIG. 2, a pair of the cameras 18 is disposed on one side in the apparatus width direction with respect to the side guide 12b disposed on the front side in the apparatus depth direction and on one side in the apparatus width direction with respect to the side guide 12b disposed on the back side in the apparatus depth direction. In this manner, the pair of cameras 18 is disposed so as to capture images of an upper portion of the stacked sheet members P from both edge sides in the width direction of the sheet members P.

### Configuration of Main Part

Next, the supply unit 14, the control unit 40, and the like will be described.

### Detailed Configuration of Supply Unit 14

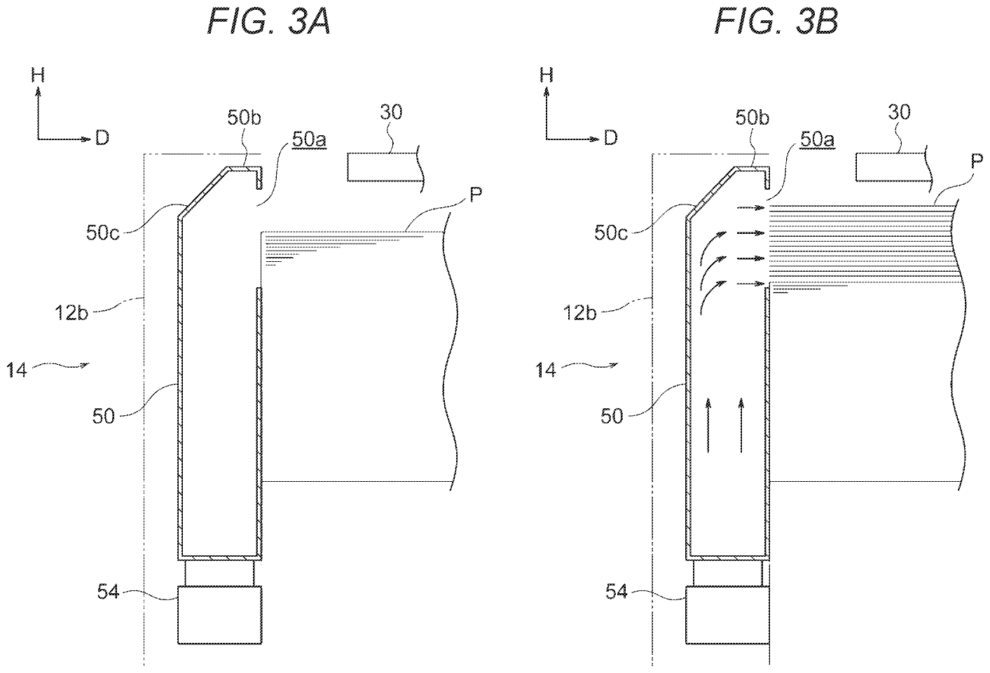

As illustrated in FIGS. 3A and 3B, the supply unit 14 includes the duct 50 and the blower 54.

### Duct 50

As illustrated in FIGS. 3A and 3B, the duct 50 extends in the up-down direction, and the supply port 50a is formed in an upper end portion of the duct 50 on a side facing the stacked sheet members P.

In addition, a top plate of the duct 50 has a horizontal portion 50b extending in the apparatus depth direction and an inclined portion 50c inclined with respect to the horizontal direction when viewed from the apparatus width direction. Specifically, the horizontal portion 50b is formed on a side closer to the supply port 50a, and the inclined portion 50c is formed on a side opposite to the supply port 50a. The inclined portion 50c is inclined with respect to the horizontal direction such that the side closer to the supply port 50a is higher than the side opposite to the supply port 50a.

### Blower 54

As illustrated in FIGS. 3A and 3B, the blower 54 is disposed on the lower side of the duct 50 and supplies air into the duct 50.

With this configuration, as illustrated in FIG. 3B, the air supplied into the duct 50 by the blower 54 rises inside the duct 50 and is supplied (blown) to the edge side of the sheet member P to be stacked through the supply port 50a. Then, the air is supplied between the stacked sheet members P at the upper portion so that the plurality of sheet members Pare floated and separated.

### Control Unit 40

### Hardware Configurations of Control Unit 40

As illustrated in FIG. 4A, the control unit 40 includes a central processing unit (CPU) 41, a read only memory (ROM) 42, a random access memory (RAM) 43, a storage 44, and a communication interface (I/F) 45. The respective configurations are connected to each other via a bus 49 to be capable of communicating with each other. The CPU 41 is an example of a processor.

The CPU 41 is a central processing unit, and executes various programs or controls each unit. That is, the CPU 41 reads the programs from the ROM 42 or the storage 44 and executes the programs using the RAM 43 as a work area. The CPU 41 performs control of the respective configurations and various types of arithmetic processing in accordance with the programs stored in the ROM 42 or the storage 44.

In this embodiment, for example, the ROM 42 or the storage 44 stores a determination program for determining whether or not a fold is generated in the stacked sheet members P from the images captured by the cameras 18. The fold is an example of a shape defect.

The RAM 43 serves as the work area and temporarily stores a program or data. The storage 44 is configured using a hard disk drive (HDD) or a solid state drive (SSD), and stores various programs including an operating system and various types of data.

The communication interface 45 is an interface for the control unit 40 to communicate with the cameras 18, the transport unit 16, the blower 54, the image forming unit 102, and the like, and a standard such as Ethernet (registered trademark), FDDI, or Wi-Fi (registered trademark) is used.

When driving programs are executed, the control unit 40 implements various functions using hardware resources. Functional configurations of the control unit 40 that enables the control unit 40 to implement the various functions will be described.

### Functional Configurations of Control Unit 40

As illustrated in FIG. 4B, the control unit 40 includes a reception unit 46, a determination unit 47, and an operation unit 48. Each of the functional configurations is implemented by causing the CPU 41 to read and execute the driving program stored in the ROM 42 or the storage 44. Details of the control unit 40 will be described together with an effect to be described below.

### Effect of Configuration of Main Part

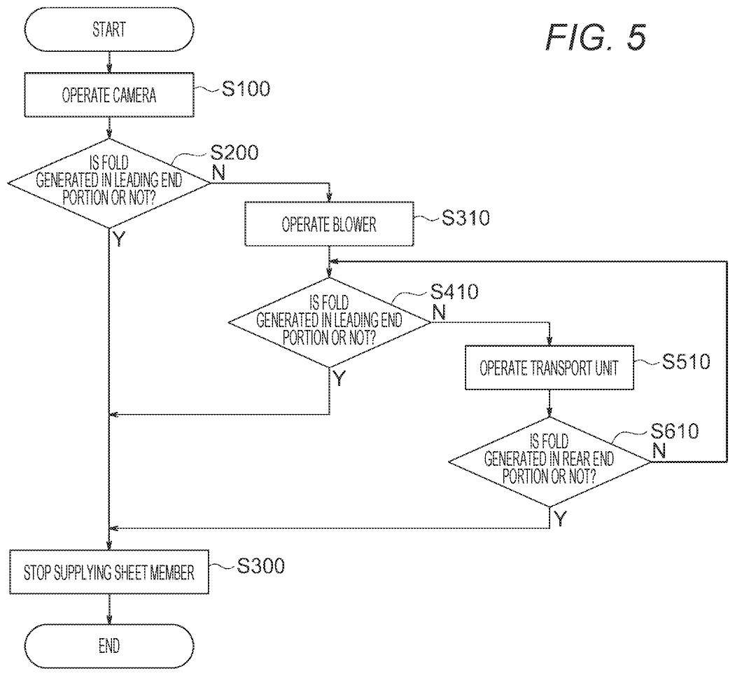

Next, a determination process in which the control unit 40 of the medium supply apparatus 10 determines whether or not a fold is generated in the sheet members P stacked on the medium supply apparatus 10 will be described with reference to a flowchart of FIG. 5.

When a plurality of sheet members P are stacked on the bottom plate 12a and the reception unit 46 of the control unit 40 receives an instruction to supply the sheet members P to the image forming unit 102, the operation unit 48 operates the pair of cameras 18 to capture images of the leading end portions of the stacked sheet members P from one side and the other side in the width direction of the sheet members P in step S100.

In step S200, the determination unit 47 determines whether or not a fold is generated in the leading end portions of the stacked sheet members P from the images captured by the camera 18. Specifically, the determination is performed separately for a fold generated in the leading end portion of the uppermost sheet member P (hereinafter, may be referred to as a “top sheet member P”) and a fold generated in the leading end portion of the sheet member P sandwiched between the sheet members P in the up-down direction (hereinafter, may be referred to as an “intermediate sheet member P”).

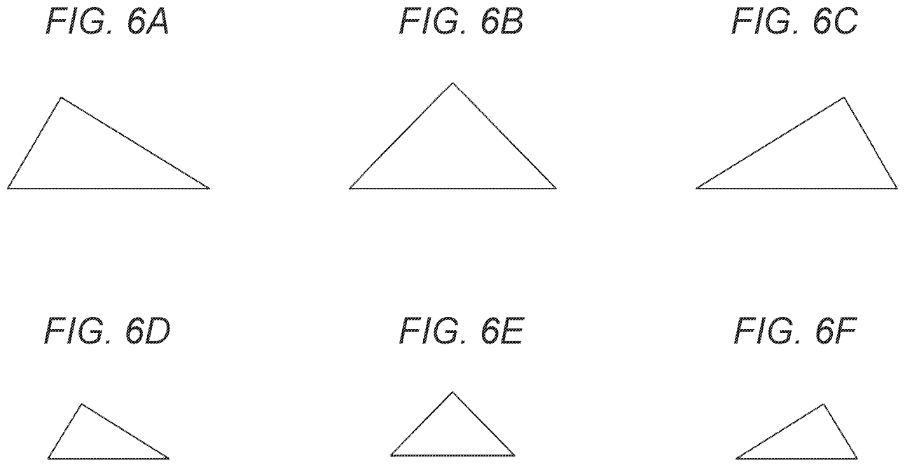

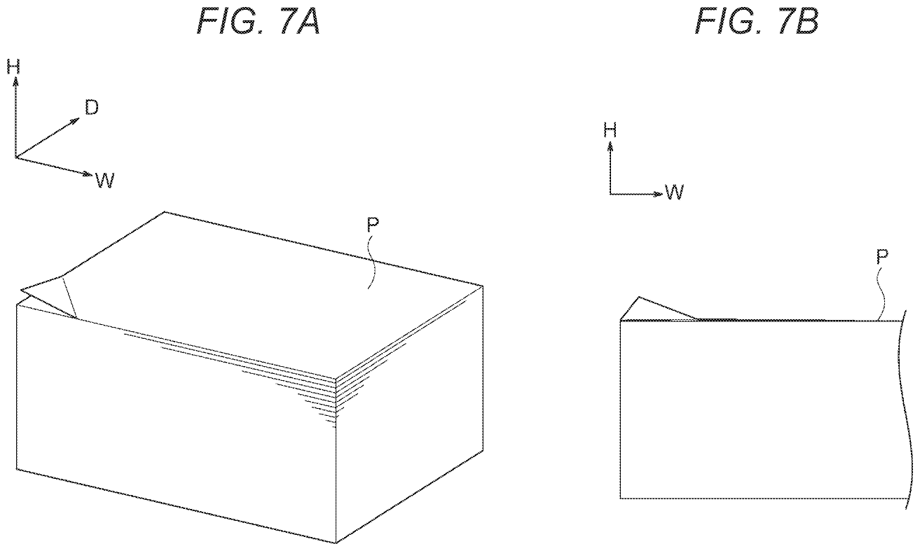

First, as an example, pattern matching is used to determine whether or not a fold is generated the leading end portion of the top sheet member P. Specifically, a plurality of triangular patterns (see FIGS. 6A to 6F) as fold shapes are stored in advance in the ROM 42. Meanwhile, as illustrated in FIGS. 7A and 7B, when a fold is generated in the top sheet member P, a folded portion is visually recognized as a triangle as viewed from edge sides of the top sheet member P.

Then, the determination unit 47 evaluates a degree of similarity between a shape recognized in the image captured by the cameras 18 and the triangular pattern stored in advance. This evaluation is repeated for each of the triangular patterns. When the degree of similarity is equal to or higher than a predetermined threshold, the determination unit 47 determines that the fold is generated in the leading end portion of the top sheet member P. The degree of similarity can be evaluated using, for example, a cross-correlation coefficient between pixel values.

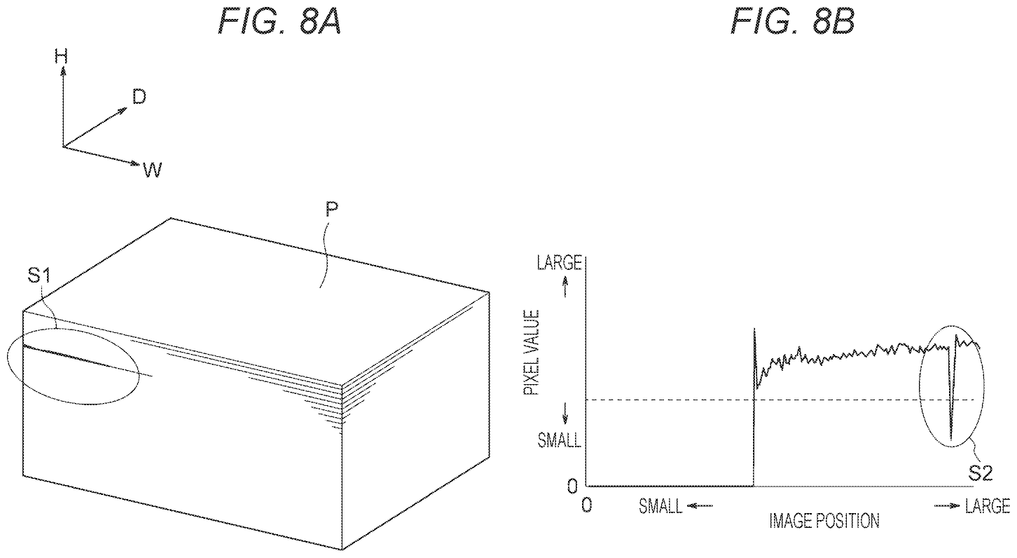

On the other hand, as an example, a pixel value of a captured image is used to determine whether or not a fold is generated in the intermediate sheet member P. To be more specific, when a fold is generated in the intermediate sheet member P, a crack S1 is formed between the sheet members P stacked in the up-down direction as illustrated in FIG. 8A.

Then, the determination unit 47 vertically scans the images captured by the cameras 18, and determines that the crack SI is generated when detecting that pixel values of RGB have values lower than predetermined thresholds. In other words, the determination unit 47 determines that the fold is generated in the leading end portion of the intermediate sheet member P. FIG. 8B illustrates a graph in which a vertical axis represents a pixel value and a horizontal axis represents an image position. A portion S2 in FIG. 8B is a place lower than the predetermined threshold, the place having the crack S1.

The process proceeds to step S300 in a case where it is determined that the fold is generated in the leading end portion of the top sheet member P or in the leading end portion of the intermediate sheet member P or proceeds to step S310 in a case where it is determined that there is no fold in the leading end portions of the sheet members P.

In step S300, the operation unit 48 causes the cameras 18 not to operate, the generation of the fold in the sheet members P is displayed on a user interface (not illustrated), and the determination process is ended. In other words, the supply of the sheet member P is stopped, the generation of the fold in the sheet members P is displayed on the user interface (not illustrated), and the determination process is ended.

On the other hand, when it is determined that there is no fold in the leading end portions of the sheet members P the process proceeds to step S310, the operation unit 48 operates the blower 54 in step S310 to supply air to the sheet members P from the edge side of the sheet members P, thereby floating and separating the sheet member P.

In step S410, the determination unit 47 determines whether or not a fold is generated in the leading end portions of the floating and separated sheet members P from images captured by the cameras 18. Since the sheet members P are separated and floating, the above-described pattern matching is used for the determination of a fold of the intermediate sheet member P. Thus, the fold of the intermediate sheet member P is also determined with high accuracy.

Then, the process proceeds to step S300 in a case where it is determined that the fold is generated in the leading end portion of the sheet member P or proceeds to step S510 in a case where it is determined that there is no fold in the leading end portions of the sheet members P.

In step S510, the operation unit 48 operates the transport unit 16. Specifically, the operation unit 48 operates the suction unit 30 to suck the floating top sheet member P, and moves to one side in the apparatus width direction in a state of sucking the top sheet member P to transport the top sheet member P. Further, the operation unit 48 operates the feeding roller 26 to receive the top sheet member P transported by the suction unit 30 and transport the received top sheet member P toward the image forming unit 102.

In step S610, as the top sheet member P is transported, images of a rear end portion of the top sheet member P are captured by the cameras 18, and the determination unit 47 determines whether or not a fold is generated in the rear end portion of the top sheet member P being transported from the images captured by the cameras 18. The above-described pattern matching is used to determine the fold of the rear end portion of the top sheet member P. Thus, the fold of the rear end portion of the top sheet member P is also determined. Here, the rear end portion of the sheet member P is a portion including at least a portion having a length of 10 from a rear end when a length of the sheet member P in the supply direction is 100.

Then, in a case where it is determined that the fold is generated in the rear end portion of the top sheet member P, the process proceeds to step S300. In a case where it is determined that there is no fold in the rear end portion of the sheet member P, the operation of the blower 54 is continued, and the process proceeds to step S410 again to repeat the above-described process until a series of jobs is completed.

### Summary

As described above, in the medium supply apparatus 10, the control unit 40 stops the supply of the sheet member P when the images of the folded sheet member P are captured by the cameras 18. Thus, the sheet member P that is folded is prevented from being supplied to the image forming unit 102 as compared with a case where the sheet member P is directly supplied to the image forming unit 102 without checking whether or not a fold is generated in the sheet member P.

In addition, in the medium supply apparatus 10, the cameras 18 are disposed on both sides in the width direction of the sheet member P to face the leading end portion of the sheet member P. Thus, as compared with a case where the cameras 18 are disposed only on one side in the width direction of the sheet member P, the accuracy of determining whether or not a fold is generated is improved.

In addition, the medium supply apparatus 10 is provided with the transport unit 16 that moves the cameras 18 and the top sheet member P relative to each other in a supply direction (transport direction) of the top sheet member P. Thus, it is possible to determine whether or not a fold is generated in the rear end portion of the sheet member P.

In addition, in the medium supply apparatus 10, the transport unit 16 transports the top sheet member P so that the cameras 18 and the top sheet member P move relative to each other in the supply direction (transport direction) of the top sheet member P. Thus, the number of components is reduced as compared with a case where a dedicated component for relatively moving the cameras 18 and the top sheet member P is provided.

In addition, in the medium supply apparatus 10, the cameras 18 captures images of the plurality of sheet members P floated by the air supplied from the supply unit 14. Thus, a fold of the intermediate sheet member P is determined more accurately as compared with a case where the fold of the intermediate sheet member P is determined by capturing images of the sheet members P in a stacked state.

In addition, in the medium supply apparatus 10, the cameras 18 are disposed on both the sides in the width direction of the sheet member P to face the leading end portion of the sheet member P, and the sheet member P and the cameras 18 move relative to each other. Thus, it is possible to determine whether or not a fold is generated in the rear end portion of the sheet member P on both the sides in the width direction.

In addition, formation of an image on the folded sheet member P is prevented in the image forming apparatus 100 as compared with a case where a medium supply apparatus, which supplies the sheet member P to the image forming unit 102 directly without checking whether or not a fold is generated in the sheet member P, is provided.

Although the specific embodiment of the present disclosure has been described in detail, the present disclosure is not limited to such an embodiment, and it is apparent to those skilled in the art that various other embodiments can be made within the scope of the present disclosure. For example, the cameras 18 are disposed on both the sides in the width direction of the sheet member P to face the leading end portion of the sheet member P in the embodiment, but a camera may be disposed on only one side in the width direction of the sheet member P. In this case, however, an effect achieved by disposing the cameras 18 on both the sides in the width direction of the sheet member P is not achieved.

Although the transport unit 16 is used to move the cameras 18 and the sheet member P relative to each other in the above embodiment, the cameras 18 and the sheet member P may be moved relative to each other by moving the cameras. In this case, however, an effect obtained by relatively moving the cameras 18 and the sheet member P using the transport unit 16 is not achieved.

Although the supply unit 14 which supplies air to the sheet members P to float the plurality of sheet members P is provided in the above embodiment, the supply unit 14 is not necessarily provided. In this case, however, an effect achieved by providing the supply unit is not achieved.

Although not particularly described in the above embodiment, the medium supply apparatus 10 and the image forming apparatus 100 may be each configured using a single apparatus or may be configured using a plurality of apparatuses.
(((1)))

A medium supply system comprising:
imaging units that capture images of a plurality of stacked recording media from an edge side of the recording media; and
at least one processor,
wherein the processor stops supply of the recording media when it is determined that a fold is generated in the recording media from the images captured by the imaging units.
(((2)))

The medium supply system according to (((1))), wherein the imaging units are respectively disposed on both sides in a width direction of the recording media to face leading end portions of the recording media.
(((3)))

The medium supply system according to (((2))), further comprising a moving unit that relatively moves the imaging units and a recording medium from the leading end portion to a rear end portion of the recording medium in a supply direction of the recording media.
(((4)))

The medium supply system according to (((3))), wherein the moving unit is a transport unit that transports an uppermost stacked recording medium in the supply direction toward a processing apparatus that processes the recording medium.
(((5)))

The medium supply system according to any one of ((1)) to ((4)), further comprising
a supply unit that supplies air to the recording media from the edge side of the plurality of stacked recording media to float a plurality of recording media,
wherein the imaging units captures images of the plurality of recording media floated by the supply unit.
(((6)))

The medium supply system according to any one of ((1)) to ((5)), further comprising
a moving unit that relatively moves the imaging units and the recording media in a supply direction of the recording media,
wherein the imaging units are respectively disposed on both sides in a width direction of the recording media to face leading end portions of the recording media.
(((7)))

The medium supply system according to (((6))), wherein the moving unit is a transport unit that transports an uppermost stacked recording medium in the supply direction of the recording media toward a processing apparatus that processes the recording medium.
(((8)))

An image forming system comprising:
the medium supply system according to any one of ((1)) to ((7)); and
an image forming unit that serves as the processing apparatus and forms an image on each of the recording media supplied from the medium supply system.

What is claimed is:

1. A medium supply system comprising:
imaging units that capture images of a plurality of stacked recording media from an edge side of the recording media; and
at least one processor,
wherein the processor stops supply of the recording media when it is determined that a fold is generated in the recording media from the images captured by the imaging units.

2. The medium supply system according to claim 1, wherein the imaging units are respectively disposed on both sides in a width direction of the recording media to face leading end portions of the recording media.

3. The medium supply system according to claim 2, further comprising a moving unit that relatively moves the imaging units and a recording medium from the leading end portion to a rear end portion of the recording medium in a supply direction of the recording media.

4. The medium supply system according to claim 3, wherein the moving unit is a transport unit that transports an uppermost stacked recording medium in the supply direction toward a processing apparatus that processes the recording medium.

5. The medium supply system according to claim 1, further comprising
a supply unit that supplies air to the recording media from the edge side of the plurality of stacked recording media to float a plurality of recording media,
wherein the imaging units captures images of the plurality of recording media floated by the supply unit.

6. The medium supply system according to claim 5, further comprising
a moving unit that relatively moves the imaging units and the recording media in a supply direction of the recording media,
wherein the imaging units are respectively disposed on both sides in a width direction of the recording media to face leading end portions of the recording media.

7. The medium supply system according to claim 6, wherein the moving unit is a transport unit that transports an uppermost stacked recording medium in the supply direction of the recording media toward a processing apparatus that processes the recording medium.

8. An image forming system comprising:
the medium supply system according to claim 1; and
an image forming unit that serves as a processing apparatus and forms an image on each of the recording media supplied from the medium supply system.

9. An image forming system comprising:
the medium supply system according to claim 2; and
an image forming unit that serves as a processing apparatus and forms an image on each of the recording media supplied from the medium supply system.

10. An image forming system comprising:
the medium supply system according to claim 3; and
an image forming unit that serves as a processing apparatus and forms an image on each of the recording media supplied from the medium supply system.

11. An image forming system comprising:
the medium supply system according to claim 4; and
an image forming unit that serves as a processing apparatus and forms an image on each of the recording media supplied from the medium supply system.

12. An image forming system comprising:
the medium supply system according to claim 5; and
an image forming unit that serves as a processing apparatus and forms an image on each of the recording media supplied from the medium supply system.

13. An image forming system comprising:
the medium supply system according to claim 6; and
an image forming unit that serves as a processing apparatus and forms an image on each of the recording media supplied from the medium supply system.

14. An image forming system comprising:
the medium supply system according to claim 7; and
an image forming unit that serves as a processing apparatus and forms an image on each of the recording media supplied from the medium supply system.
